(19) United States
(12) Patent Application Publication
(10) Pub. No.: US 2019/0154541 A1
(43) Pub. Date: May 23, 2019

(54) ABNORMALITY DETECTION PROGRAM, ABNORMALITY DETECTION DEVICE, AND ABNORMALITY DETECTION METHOD

(71) Applicant: FUJITSU LIMITED, Kawasaki-shi (JP)

(72) Inventors: Takuya Nishino, Atsugi (JP); Mineharu Tsukada, Hadano (JP)

(73) Assignee: FUJITSU LIMITED, Kawasaki-shi (JP)

(21) Appl. No.: 16/257,227

(22) Filed: Jan. 25, 2019

Related U.S. Application Data
(63) Continuation of application No. PCT/JP2016/072059, filed on Jul. 27, 2016.

(51) Int. Cl. G01M 7/02; G01F 1/66; G01H 1/00

(52) U.S. Cl. CPC G01M 7/022; G01H 1/003; G01F 1/662; G01M 7/025

(57) ABSTRACT

A non-transitory computer-readable recording medium having stored therein an abnormality detection program for causing a computer to execute a process, the process includes referring to a storage that stores a plurality of determination criteria for each of processes based on a rotation frequency of the rotating part and harmonic frequencies of the rotation frequency in each of a plurality of processes, the rotation frequency and the harmonic frequencies of the rotation frequency being specified from a frequency spectrum of vibration data obtained by measuring, by a sensor, vibration of a monitoring target device that executes the plurality of processes in a predetermined order by using a rotating part that rotates, and detecting occurrence of an abnormality of the monitoring target device from the vibration data measured by the sensor based on the predetermined order and the plurality of determination criteria for each of the processes.

### CROSS-REFERENCE TO RELATED APPLICATION

This application is a continuation application of International Application PCT/JP2016/072059 filed on Jul. 27, 2016 and designated the U.S., the entire contents of which are incorporated herein by reference.

### FIELD

The embodiments discussed herein are related to an abnormality detection program, an abnormality detection device, and an abnormality detection method.

### BACKGROUND

Techniques for measuring, by a sensor, the vibration of monitoring target devices, which are targets of monitoring occurrence of abnormalities, such as semiconductor manufacturing equipment, vacuum pumps, centrifuges, and the like equipped with rotating parts that rotate such as a motor to detect an abnormality of the monitoring target devices from measured vibration data, have been developed. In addition, for example, in a monitoring target device such as semiconductor manufacturing equipment, operating conditions may be changed during operation and a plurality of processes may be executed, and a technique for detecting an abnormality in a monitoring target device in which a plurality of processes are executed while operating conditions are changed during operation has also been developed.

However, change of vibration data caused by abnormality of the monitoring target device may be erroneously detected as change of vibration data due to change of operating conditions of the monitoring target device.

The followings are reference documents.

### [Document 1] Japanese Laid-open Patent Publication No. 2013-88431 and

### [Document 2] Japanese Laid-open Patent Publication No. 07-218333

### SUMMARY

According to an aspect of the invention, a non-transitory computer-readable recording medium having stored therein an abnormality detection program for causing a computer to execute a process, the process includes referring to a storage that stores a plurality of determination criteria for each of processes based on a rotation frequency of the rotating part and harmonic frequencies of the rotation frequency in each of a plurality of processes, the rotation frequency and the harmonic frequencies of the rotation frequency being specified from a frequency spectrum of vibration data obtained by measuring, by a sensor, vibration of a monitoring target device that executes the plurality of processes in a predetermined order by using a rotating part that rotates, and detecting occurrence of an abnormality of the monitoring target device from the vibration data measured by the sensor based on the predetermined order and the plurality of determination criteria for each of the processes.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary abnormality detection system;

FIG. 2 is a diagram illustrating extraction of feature amounts from vibration data;

FIG. 3 is a diagram illustrating changes in a feature amount in a case where a plurality of processes are executed;

FIG. 4 is a diagram illustrating detection of switching between processes and an abnormality using feature amounts;

FIG. 5 is a diagram illustrating a waveform of normal vibration and a waveform of abnormal vibration;

FIG. 6 is a diagram illustrating frequency spectrums converted from a waveform of normal vibration and a waveform of abnormal vibration;

FIG. 7 is a diagram illustrating generation of a strain wave by synthesis of a harmonic by an inverter;

FIG. 8 is a diagram illustrating peaks of a harmonic caused by synthesis of the harmonic;

FIG. 9 is a diagram illustrating a functional block configuration of an abnormality detection device according to an embodiment;

FIG. 10 is a diagram illustrating a rotation frequency and a search for peaks of harmonics of the rotation frequency according to the embodiment;

FIG. 11 is a diagram illustrating an operation flow of learning processing according to the embodiment;

FIG. 12 is a diagram illustrating an operation flow of generation processing of determination criteria information according to the embodiment;

FIG. 13 is a diagram illustrating determination criteria information according to the embodiment;

FIG. 14 is a diagram illustrating feature amount information;

FIG. 15 is a diagram illustrating an operation flow of abnormality detection processing according to the embodiment;

FIG. 16 is a diagram illustrating another example of the determination criteria information according to the embodiment; and

FIG. 17 is a diagram illustrating a hardware configuration of a computer for realizing an abnormality detection device according to the embodiment.

### DESCRIPTION OF EMBODIMENTS

Hereinafter, some embodiments will be described in detail with reference to the drawings. Corresponding elements in the drawings are denoted by the same reference symbols.

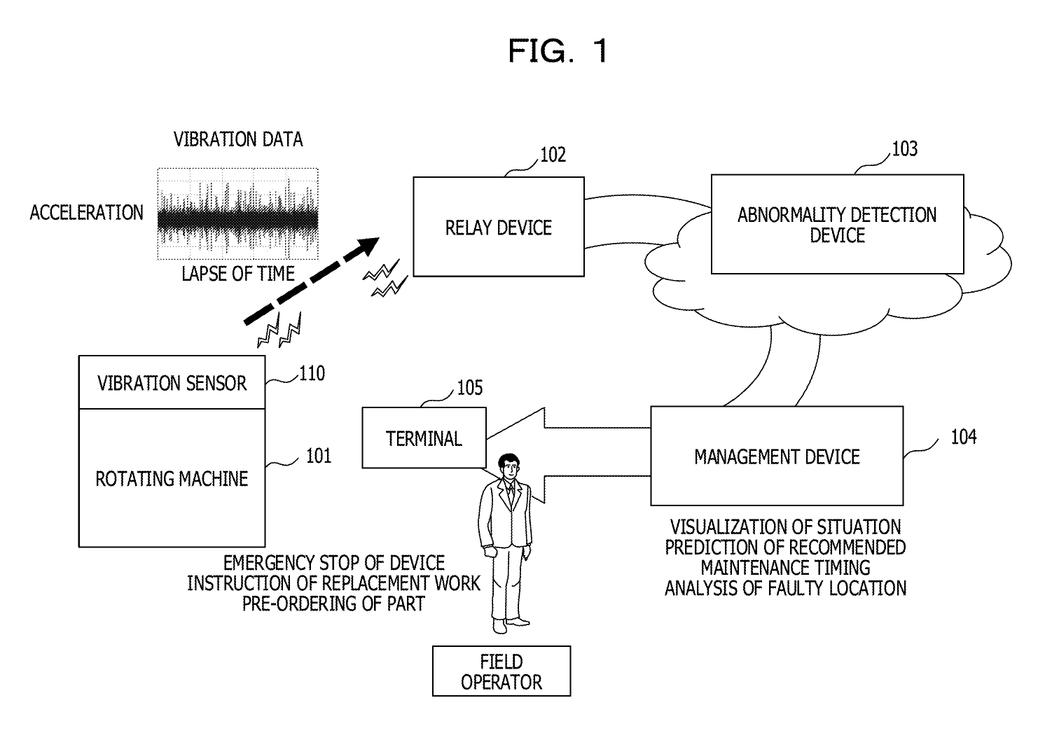

FIG. 1 is a diagram illustrating an exemplary abnormality detection system 100. The abnormality detection system 100 includes, for example, a monitoring target device 101, a relay device 102, an abnormality detection device 103, a management device 104, and an operator's terminal 105. The monitoring target device 101 may be, for example, a device including a rotating part such as a motor and may be a semiconductor manufacturing device, a vacuum pump, a centrifuge, or the like. The monitoring target device 101 may be provided with a sensor 110 for detecting vibration of the monitoring target device 101 such as an acceleration sensor and a displacement sensor. Then, the sensor 110 notifies the abnormality detection device 103 of the vibration data on the detected vibration via the relay device 102 such as a gateway, for example, by wireless communication. For example, the sensor 110 may measure data on vibration caused by rotation of rotating parts of the monitoring target device 101. For example, in a state in which the monitoring target device 101 is operated, in the sensor 110, for example, vibration data including the vibration component corresponding to the rotational speed (for example, rpm: revolution per minute) of the rotating part may be measured. The vibration component due to the rotation of the rotating part may include, for example, a component of the rotation frequency representing vibrations that appear at the cycle of the rotation frequency of the rotating part and components of the harmonics of the rotation frequency.

The abnormality detection device 103 detects an abnormality of the monitoring target device 101, for example, based on the notified vibration data and notifies the management device 104 of an abnormality. The management device 104, for example, in accordance with a notification of an abnormality, performs visualization of a situation, prediction of the timing at which maintenance of the monitoring target device 101 is recommended, analysis of a faulty location, and the like. Then, depending on the situation, the management device 104 sends instructions to the terminal 105 held by the operator and the monitoring target device 101. The instructions may be, for example, replacement work of parts, pre-ordering of parts, emergency stop of the monitoring target device 101, and the like. The operator may perform operations such as replacement of parts and ordering in accordance with the instructions notified to the terminal 105. In addition, for example, when receiving an emergency stop instruction, the monitoring target device 101 may stop urgently.

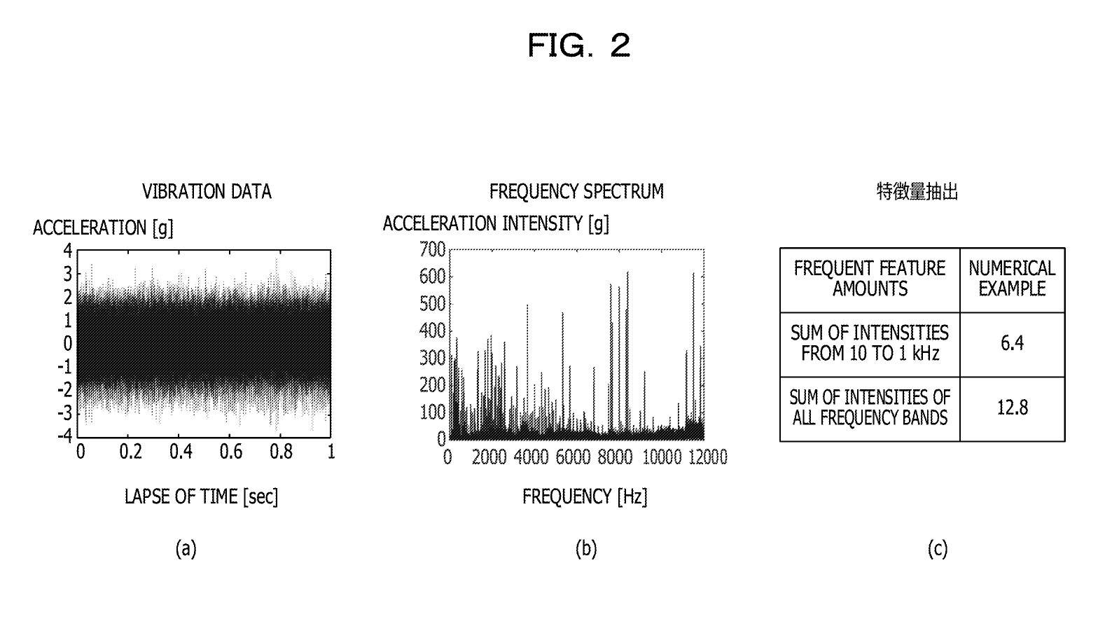

In addition, since the amount of data of the vibration data used for detecting an abnormality of the monitoring target device 101 is large, detection of an abnormality from the vibration data may be performed by, for example, by extracting feature amounts from a frequency spectrum obtained by Fourier transform of the vibration data and using the extracted feature amounts. FIG. 2 is a diagram illustrating extraction of feature amounts from vibration data. As illustrated in FIG. 2, for example, the frequency spectrum (FIG. 2(b)) is obtained by converting the vibration data (FIG. 2(a)) from the time domain to the frequency domain by Fourier transform. Then, for example, feature amounts may be obtained from the frequency spectrum by integrating the intensities in a predetermined frequency range of the frequency spectrum. For example, FIG. 2(c) illustrates an example in which the sum of the intensities of the frequency spectrum from 1 kHz to 10 kHz obtained from the vibration data detected by the sensor 110 in a predetermined period and the sum of the intensities of all frequency bands are extracted as feature amounts.

The frequency range used for extracting the feature amounts may be set to an arbitrary range, and for example, the frequency range defined by the International Organization for Standardization (ISO) may be used as a feature amount. Then, for example, when the monitoring target device 101 is operating normally, a feature amount is acquired and learned, and a threshold value is set according to the learned feature amount. As a result, it is possible to determine that an abnormality has occurred in a case where a feature amount fluctuates beyond the threshold value during the operation of the monitoring target device 101.

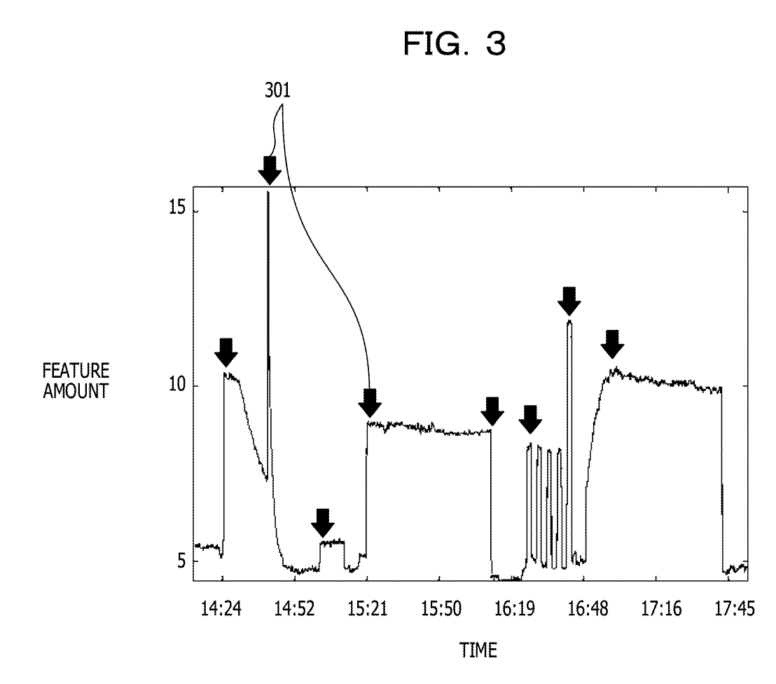

In addition, for example, in the monitoring target device 101 such as a semiconductor manufacturing device or the like, a plurality of processes may be executed while operating conditions are changed during operation. FIG. 3 is a diagram illustrating changes in a feature amount in a case where a plurality of processes are executed. In FIG. 3, an arrow 301 indicates the timing of switching between the processes, and as illustrated in FIG. 3, the feature amount fluctuates as the process is switched.

In such execution of a plurality of processes by the monitoring target device 101, conditions of each process may change due to a production plan or the like, and for example, the time for executing each process varies. Therefore, there are situations in which it is difficult to set process switching timing in advance depending on time. However, in such execution of a plurality of processes by the monitoring target device 101, the order of processes to be executed is fixed in many cases even though the time for executing the processes varies. Therefore, for example, by holding the order of the processes and the feature amount in each process, it is possible to detect switching between the processes or an abnormality of the monitoring target device 101 from the change of the feature amount.

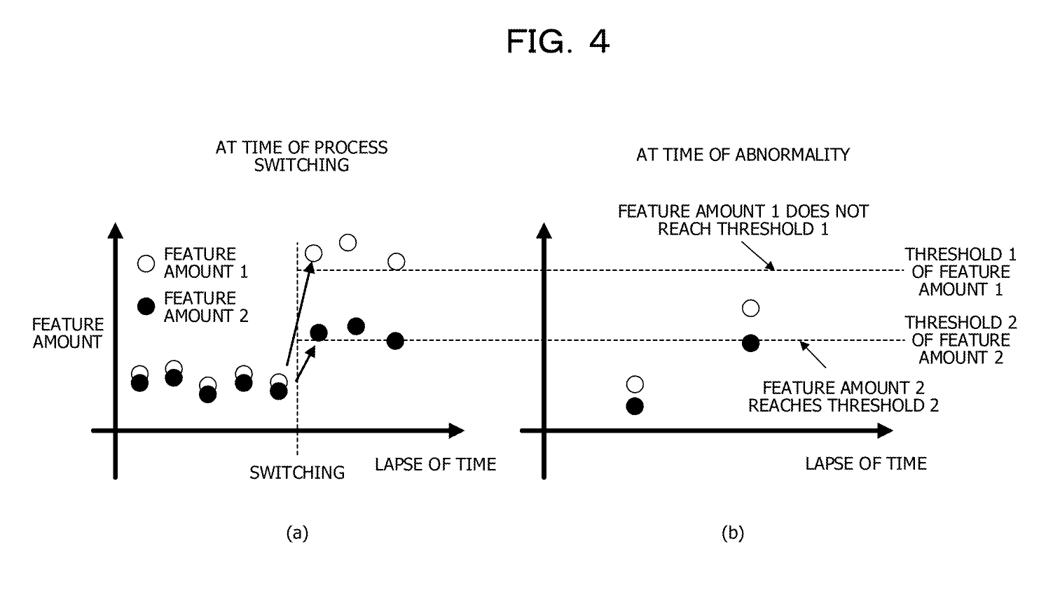

FIG. 4 is a diagram illustrating detection of switching between processes and an abnormality using feature amounts. For example, vibration data is acquired from the sensor 110 in a state in which the monitoring target device 101 is operating normally, and a feature amount in a predetermined frequency domain at the time of switching between the processes is learned from the frequency spectrum of the vibration data. A plurality of frequency ranges may be set and a plurality of feature amounts may be acquired. Then, a threshold is set based on the feature amount obtained by learning. For example, in FIG. 4(a), two feature amounts of a feature amount 1 and a feature amount 2 are illustrated, and a threshold 1 and a threshold 2 are set for the feature amount 1 and the feature amount 2, respectively. Then, as illustrated in FIG. 4(a), it is assumed that, for example, the vibration data which has indicated a normal value of the feature amount before process switching deviates from the normal value of the process. Even in this case, if the deviated feature amount changes to a normal value of the feature amount of a next process while exceeding a threshold value, it may be determined that the change of the vibration data is caused by the switching between the processes. On the other hand, for example, in FIG. 4(b), the feature amount 2 indicates a normal value of the feature amount of the next process, but the feature amount 1 is lower than the threshold 1 and deviates considerably from the normal value of the feature amount in the next process. Therefore, FIG. 4(b) may be determined as an abnormality. In this way, it is possible to detect switching between processes or an abnormality of the monitoring target device 101 by using the feature amount extracted from the vibration data.

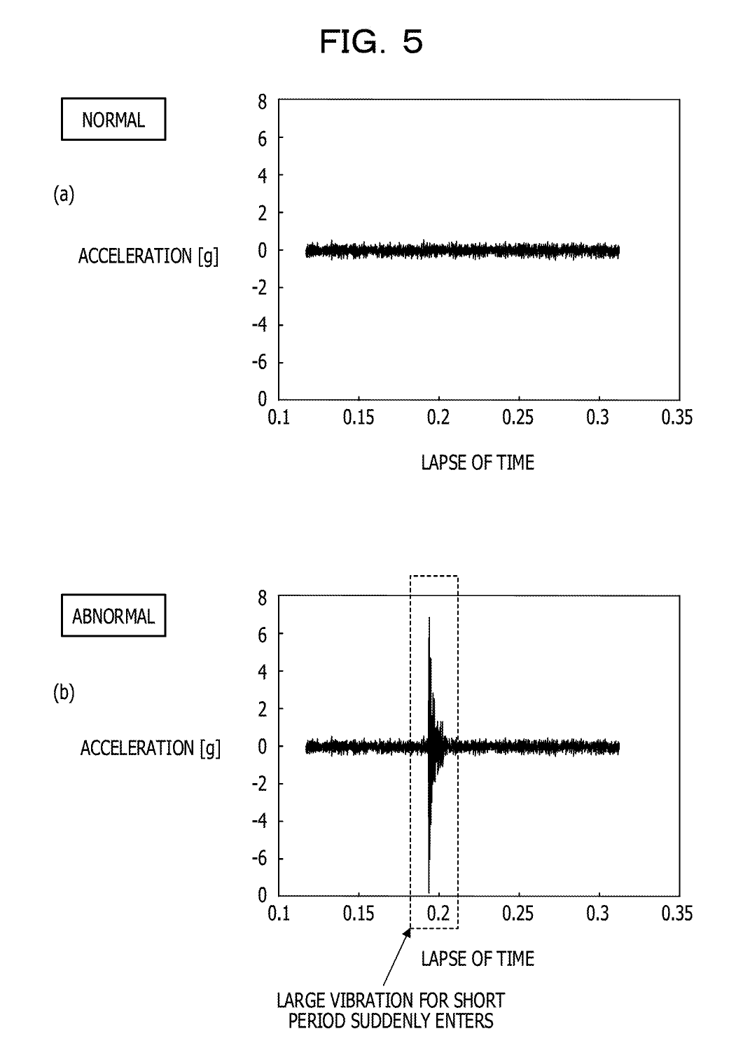

However, it is sometimes difficult to distinguish a change in a feature amount due to process switching from a change in a feature amount due to occurrence of an abnormality such as a case where a change in the feature amount due to the occurrence of an abnormality results in a value similar to the normal value of a feature amount in the next process. FIG. 5 is a diagram illustrating a waveform of normal vibration and a waveform of abnormal vibration. FIG. 5(a) illustrates, for example, the waveform of normal vibration. In addition, FIG. 5(b) illustrates a waveform at the time of an abnormality, for example, in a case where a sediment or the like falls into the monitoring target device 101 and an impact is applied from the outside. In a case where an impact is suddenly applied from the outside, for example, as illustrated in FIG. 5(b), large vibration suddenly appears for a short period.

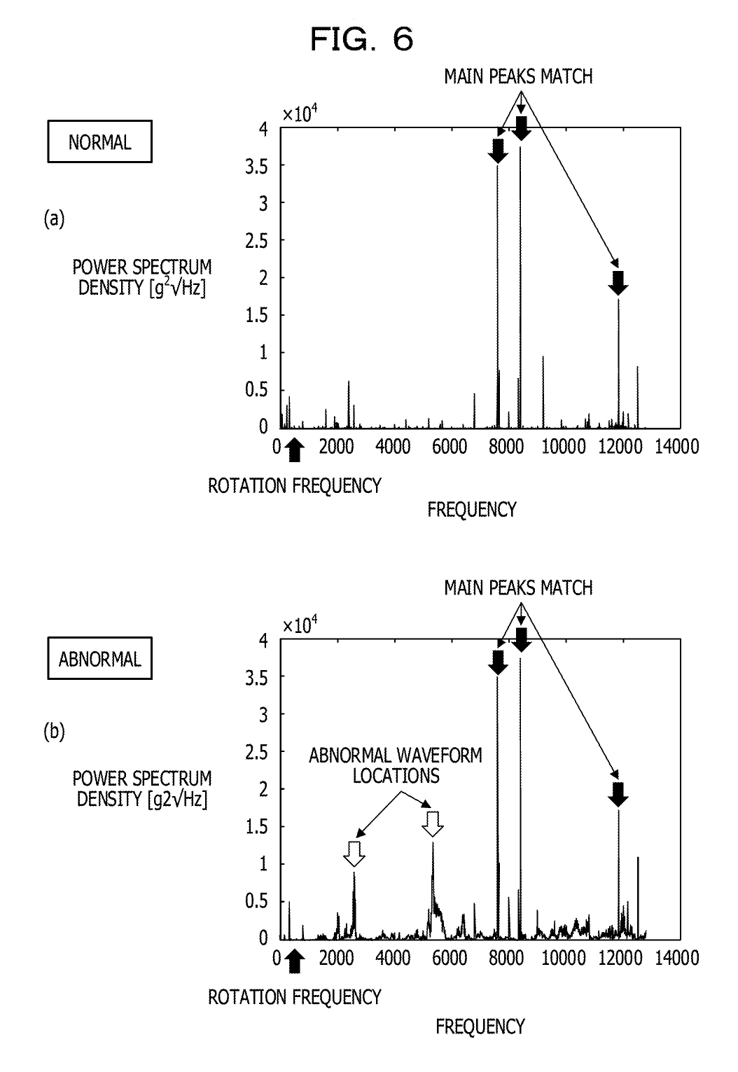

In addition, FIG. 6 illustrates a waveform obtained by converting the waveform of normal vibration and the waveform of abnormal vibration in FIG. 5 into a frequency spectrum. FIG. 6(a) illustrates, for example, a frequency spectrum in a normal state. In addition, FIG. 6(b) illustrates the frequency spectrum corresponding to FIG. 5(b) at the time of an abnormality in a case where an impact is applied. In a case where a shock is applied from the outside, for example, in the frequency spectrum, as illustrated in FIG. 6(b), main peaks coincide with those in the normal state in FIG. 6A, but abnormal peaks appear as peaks different from the main peaks. Then, for example, in a case where a signal intensity in an arbitrary predetermined frequency range is used as the feature amount in the situation where such abnormal peaks are occurring, as a result of abnormal peaks entering the region, the feature amount may change to a value similar to the feature amount of the next process. Then, for example, in such a case, if an abnormality is detected based on a feature amount obtained from the arbitrary predetermined frequency range, there is a possibility that erroneous determination is made as normal due to change of switching to the next process despite the occurrence of an abnormality. Therefore, for example, in such a case, a technique capable of detecting an abnormality of the monitoring target device 101 with high accuracy is desired.

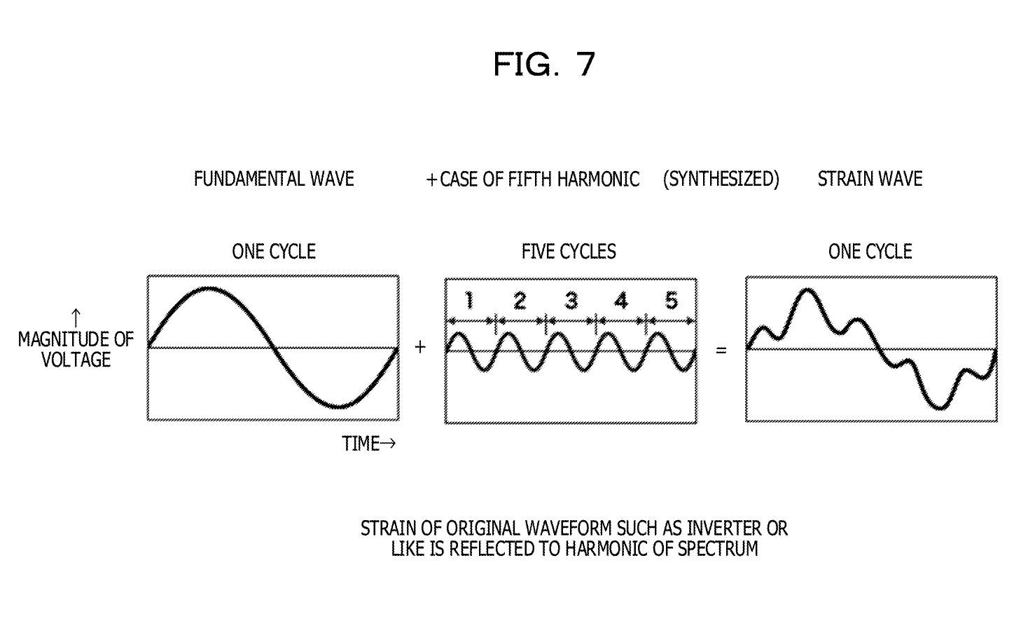

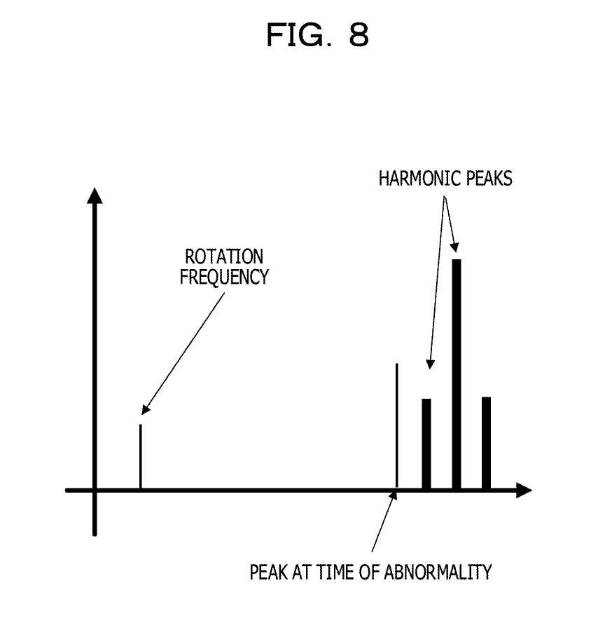

Furthermore, for example, there is a case where the number of revolutions of a rotating part such as a motor provided in the monitoring target device 101 is controlled by using an inverter or the like. In this case, for example, as illustrated in FIG. 7, the number of revolutions is controlled by synthesizing the waveform of the harmonic (fifth harmonic in FIG. 7) waveform to the fundamental waveform by using the inverter to generate a strain wave. In the case of synthesizing a harmonic in this way, as illustrated in FIG. 8, the waveform of the synthesized harmonic wave becomes a huge peak in the frequency spectrum. Then, for example, in a case where the change in the feature amount is monitored in the region including the peaks of the harmonic caused by the inverter, the peaks of the harmonic caused by the inverter becomes large. As a result, change of the feature amount due to an abnormality becomes relatively small as compared with the peaks of the harmonic caused by the inverter, and therefore the abnormality may not be detected in some cases. For this reason, even in a case where a waveform is processed by using the inverter or the like, a technique capable of detecting an abnormality with high accuracy is desired.

Therefore, in the following embodiment, in a state in which the monitoring target device 101 executing a plurality of processes in a predetermined order by using the rotating part is normally operated, a rotation frequency and peak positions of the harmonics of the rotation frequency of each process are specified from the vibration data obtained by measuring the vibration of the monitoring target device 101 with the sensor. Then, a plurality of determination criteria are generated for each process based on the specified rotation frequency and the peak positions of the harmonics of the rotation frequency. The plurality of determination criteria may be, for example, a plurality of frequency domains corresponding to each process set around each of the rotation frequency and the harmonic frequencies of the rotation frequency in each process. For example, in a case where the frequency spectrum of the vibration data notified from the sensor includes a peak in the plurality of frequency domains set as a plurality of determination criteria corresponding to a certain process, it may be determined that the process is being executed. In addition, for example, it is assumed that, after that, the frequency spectrum of the vibration data notified from the sensor does not include a peak in at least one frequency domain of the plurality of frequency domains set as a plurality of determination criteria corresponding to a certain process. In this case, if the frequency spectrum based on the vibration data from the sensor includes a peak in the plurality of frequency domains set as a plurality of determination criteria corresponding to the next process in the predetermined order, it may be determined that the monitoring target device 101 has switched the process. On the other hand, for example, in a case where the frequency spectrum based on the vibration data from the sensor does not include a peak in at least one frequency domain of the plurality of frequency domains set as a plurality of determination criteria corresponding to the next process in the predetermined order, it may be determined as an abnormality. Therefore, for example, unlike the case where an abnormality is detected by using the feature amount obtained from the same arbitrary predetermined frequency domain before and after the aforementioned change point, an abnormality is determined based on the rotation frequency and the harmonic peak positions of the rotation frequency corresponding to the process, it is possible to detect an abnormality with high accuracy.

In addition, in the embodiment described below, furthermore, in the frequency spectrum of the vibration data measured by the sensor, it is assumed that a peak exists in the plurality of frequency domains corresponding to each of the rotation frequency and peaks of the harmonics of the rotation frequency corresponding to the process. In that case as well, it is determined whether or not the peak intensity of the peaks existing in the plurality of frequency domains is approximately the same as the peak intensity acquired while the monitoring target device 101 is operating normally. Therefore, for example, even if an abnormal peak overlaps with the peak of the rotation frequency or the harmonics of the rotation frequency, it is possible to detect the abnormality from the value of the peak intensity different from the value at a normal time. Therefore, according to the embodiment, it is possible to detect an abnormality with high accuracy. Hereinafter, the embodiment will be described in more detail.

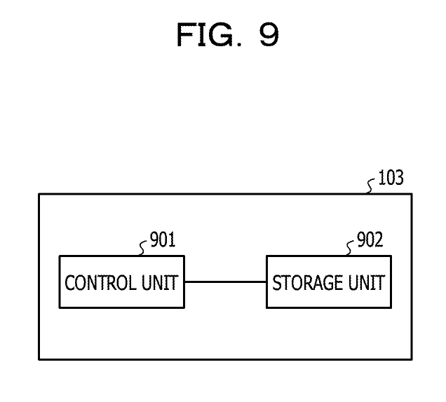

FIG. 9 is a diagram illustrating a functional block configuration of the abnormality detection device 103 according to an embodiment. The abnormality detection device 103 includes, for example, a control unit 901 and a storage unit 902. The control unit 901 controls each unit of the abnormality detection device 103. In addition, the storage unit 902 of the abnormality detection device 103 may store information such as determination criteria information 1300 and feature amount information 1400 to be described later, for example. Details of the control unit 901 and details of information stored in the storage unit 902 will be described later.

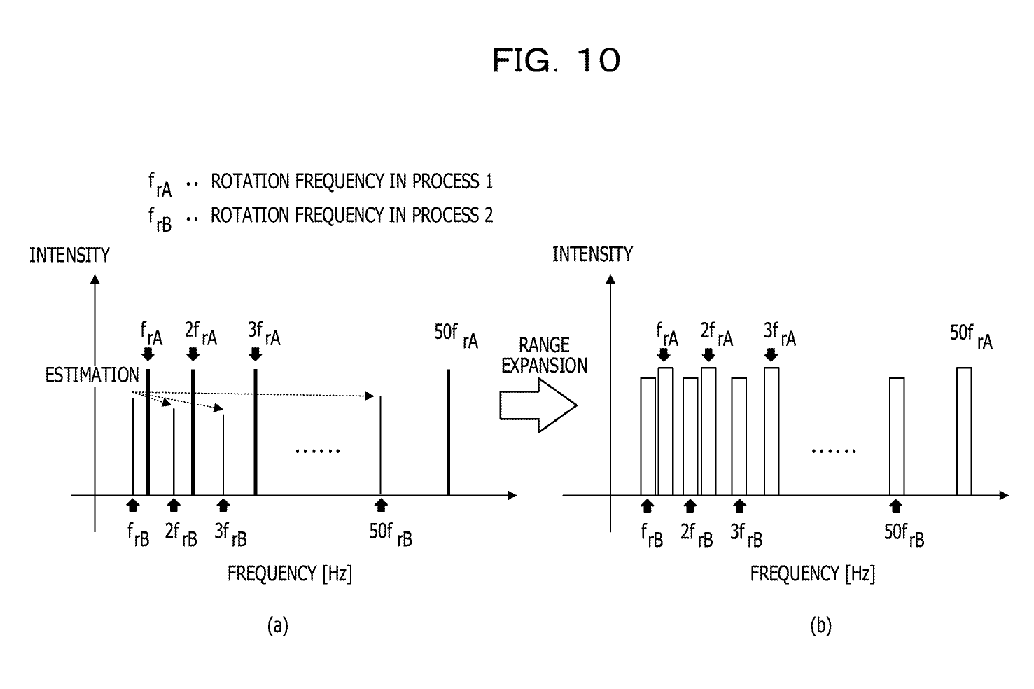

FIG. 10 is a diagram illustrating a rotation frequency and a search for peaks of the harmonics of the rotation frequency according to the embodiment. Hereinafter, a rotation frequency in each process executed by the control unit 901 and a procedure of searching the peaks of the harmonics of the rotation frequency will be exemplified.

(Procedure 1)

For example, the control unit 901 searches for and specifies a peak of the rotation frequency of each process from the frequency spectrum in each process of the vibration data measured by the sensor 110 (for example, specifies fᵣA in a process 1 and fᵣB in a process 2 in FIG. 10(a)). For example, the control unit 901 may perform a peak search from a low-frequency side and detect a peak not less than a predetermined threshold to specify a peak of the rotation frequency.

(Procedure 2)

The control unit 901, for example, determines an initial search position of the peaks of the harmonic based on the rotation frequency corresponding to the process of detecting. For example, the control unit 901 may estimate a peak position of the harmonic by multiplying the rotation frequency by an integral number and use the peak position as an initial search position for searching the harmonic (broken line arrow in FIG. 10(a)).

(Procedure 3)

For example, the control unit 901 broadens the frequency domain from the initial search position to acquire the sum of the intensities and specifies a position where the inclination of the sum of changing intensities becomes a local maximum value as a peak position of the harmonic. For example, the frequency domain that broadens the search range may be set as follows. For example, the control unit 901 may set the search range corresponding to the peak of each harmonic in accordance with the resolution of the frequency spectrum. For example, in a case where the rotation frequency specified in the above (1) is 100 Hz and resolution of the frequency spectrum is 1 Hz, actually, the rotation frequency: 100 Hz includes an error according to the resolution in the range of 99.5 Hz to 100.4 Hz. For example, in the case of a second harmonic, the error of this frequency falls within an error in a narrow frequency range from 199 Hz to 200.8 Hz, but in the case of a 50th harmonic, the frequency range is 4975 Hz to 5020 Hz, which is a wide range. Therefore, for example, the control unit 901 may set the frequency range obtained by multiplying the error range according to the resolution of the frequency spectrum by the order of the harmonic as an upper limit of the search range and perform search while expanding the search range from the initial search position to the upper limit of the search range (FIG. 10(b)). In the above example, for example, the upper limit of the search range may be set in the range of 199 Hz to 200.8 Hz in the case of the second harmonic, and 4975 Hz to 5020 Hz in the case of the 50th harmonic, which is in the range of 45 Hz, and the like.

As described above, the control unit 901 may specify a rotation frequency and the peaks of the harmonic of the rotation frequency. Then, the control unit 901 learns the peak of the specified rotation frequency and the peaks of the harmonics of the rotation frequency as a state in which the monitoring target device 101 is operating normally.

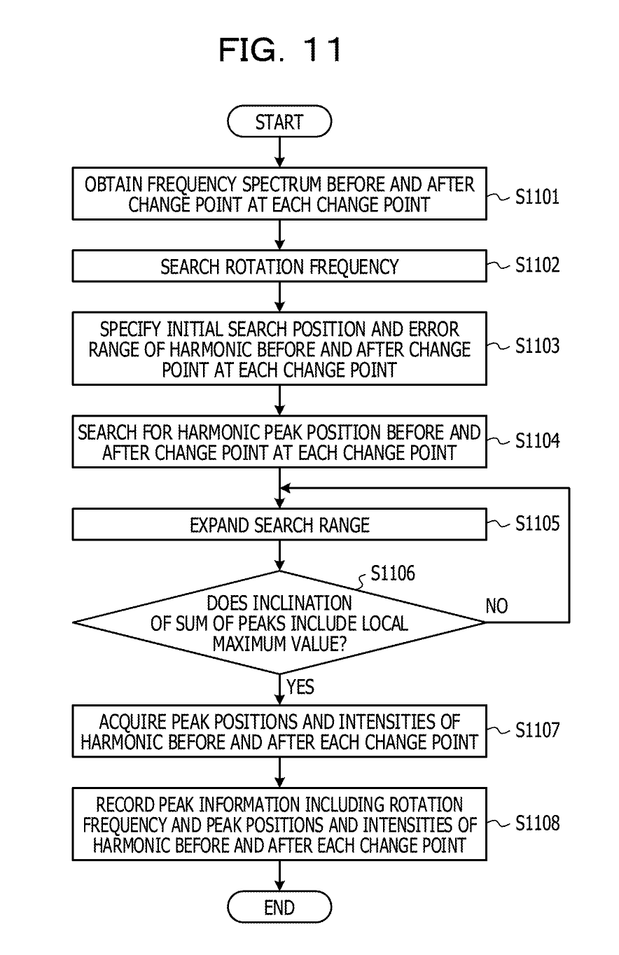

FIG. 11 is a diagram illustrating an operation flow of learning processing according to the embodiment. For example, when an execution instruction of the learning processing is input from a user, the control unit 901 may start the operation flow of FIG. 11. In the example of FIG. 11, it is assumed that vibration data at the time of execution of all of the plurality of processes has been acquired from the sensor 110 in a state in which the monitoring target device 101 is normally operated at the start point of the operation flow. In addition, it is assumed that the change point which is a process switching timing is also specified from the vibration data. The change point may be specified, for example, by using the sum of the intensities in a predetermined frequency range of the frequency spectrum of the vibration data as a feature amount and monitoring the change in the feature amount.

In step 1101 (hereinafter, the step is described as “S”, for example, denoted as S1101), at each change point, the control unit 901 obtains a frequency spectrum by converting each of the vibration data before the change point and the vibration data after the change point by the Fourier transform.

In S1102, at each change point, the control unit 901 searches the frequency spectrum before and after the change point from the low-frequency side to specify the peak having a value larger than the predetermined threshold as a rotation frequency of the rotating part provided in the monitoring target device 101.

In S1103, at each change point, the control unit 901 specifies an initial search position for searching for a peak of the harmonic of the rotation frequency and the error range indicating the upper limit of the search range for searching for the peak position based on the rotation frequency specified in the frequency spectrum before and after the change point. For example, the control unit 901 may estimate a peak position of the harmonic by multiplying the rotation frequency by an integral number and use the peak position as an initial search position for searching the harmonic. In addition, the control unit 901 may use the frequency range obtained by multiplying the error range based on the resolution of the frequency spectrum by the order of the harmonic as the error range indicating the upper limit of the search range.

For example, in a case where the rotation frequency specified in S1102 is 100 Hz and the resolution of the frequency spectrum is 1 Hz, actually, there is a possibility that an error may be included in the range corresponding to the resolution, such as 99.5 Hz to 100.4 Hz, at the rotation frequency: 100 Hz. Then, for example, in a case where the harmonic is the second harmonic, the control unit 901 may double this error range and set the range of 199 Hz to 200.8 Hz as an upper limit error range for searching for a peak of the second harmonic. In addition, for example, in the case of the 50th harmonic, an error range corresponding to the resolution such as 99.5 Hz to 100.4 Hz may be multiplied by 50 and 4975 Hz to 5020 Hz may be set as an upper limit error range for searching for the peak of the 50th harmonic.

In S1104, the control unit 901 starts searching for the position of the peaks of the harmonic with a predetermined frequency domain around the initial search position including the initial search position set for each harmonic as the search range in the frequency spectrum before and after the change point of each changing point.

In S1105, the control unit 901 expands the search range by a predetermined frequency. In the case where the processing of S1105 is executed first after the operation flow of FIG. 11 is started, expansion of the frequency range in S1105 may not be executed. In addition, expansion of the search range may be gradually expanded, for example, to the error range set in S1104.

In S1106, the control unit 901 obtains the sum (integral value) of the peak intensities within the search range after expansion and determines whether or not the inclination of the sum of the intensities according to the expansion of the search range includes a local maximum value. If the local maximum value is not included in S1106 (NO in S1106), the flow returns to S1105 to expand the search range and repeat the processing. On the other hand, in a case where the local maximum value is included in S1106 (YES in S1106), the flow proceeds to S1107.

In S1107, at each change point, the control unit 901 specifies a position of the local maximum value for each harmonic specified in S1106 before and after each change point as a peak position of the harmonic and also acquires the intensity of the peak of the harmonic.

In S1108, for example, the control unit 901 records the peak information including the rotation frequency before and after the change point specified in S1102, the peak position before and after the change point of the peak of each harmonic specified in S1107, and the intensity thereof in the storage unit 902, and this operation flow ends.

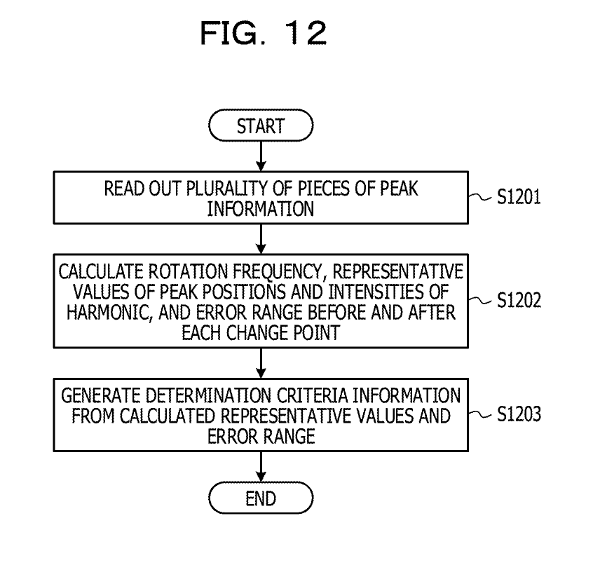

Subsequently, FIG. 12 is a diagram illustrating an operation flow of generation processing of the determination criteria information 1300 according to the embodiment. For example, the control unit 901 may start the operation flow of FIG. 12 when an execution instruction of generation processing of determination criteria information 1300 is input from the user.

In S1201, the control unit 901 executes the operation flow of FIG. 11 a plurality of times for the plurality of processes executed in the predetermined order and reads out a plurality of pieces of past peak information recorded in the storage unit 902. In S1202, from the rotation frequency before and after each change point, the peak position and intensity of the harmonic included in each piece of the read peak information, the control unit 901 calculates the rotation frequency, representative values of the peak positions and intensities of the harmonics, and the error range of representative values before and after each changing point. For example, the control unit 901 may acquire the rotation frequency before and after the change point and the peak position and intensity of the harmonic from each piece of peak information, calculates an average value for each of the peak position and the peak intensity, and uses the average value as a representative value. In addition, the standard deviation may be used as an error range of the representative values. The representative value is not limited to the average value but may be other statistics such as a local maximum value, a local minimum value, a median value, and a mode value, for example. In addition, the error range is not limited to the standard deviation but may be set as a range from the local maximum value to the local minimum value for the process obtained from each piece of peak information for each of the peak position and the peak intensity.

In S1203, the control unit 901 generates the determination criteria information 1300 for each change point from the rotation frequency before and after the change point calculated in step S1202 and the representative value and error range for the peak position and intensity of the harmonic and stores the determination criteria information 1300 in the storage unit 902, and this operation flow ends.

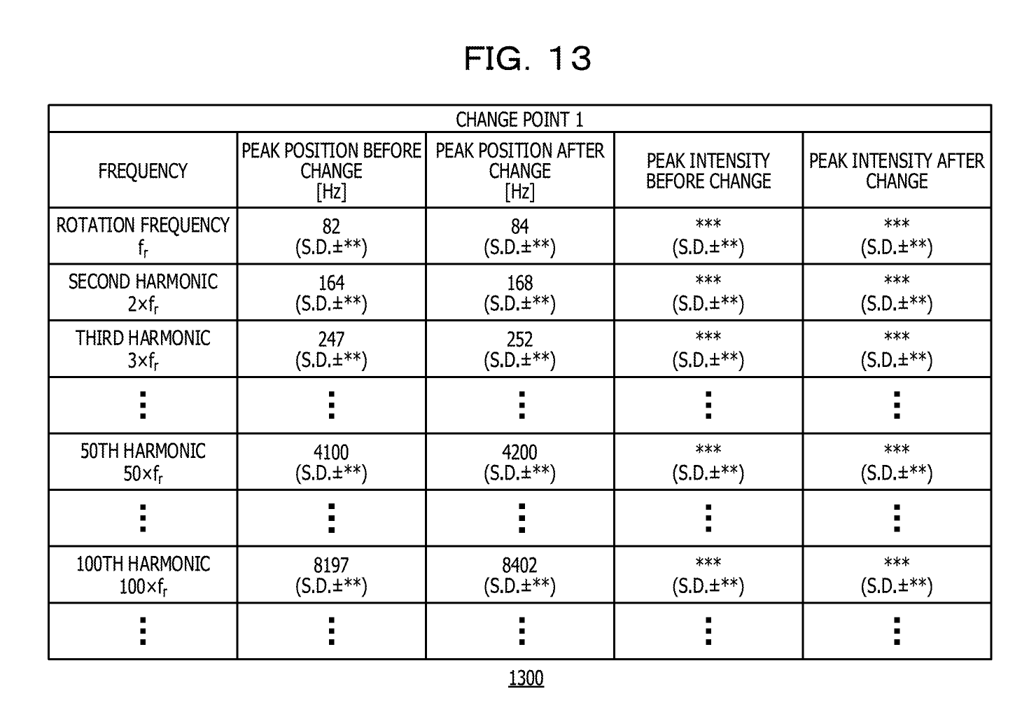

FIG. 13 is a diagram illustrating the determination criteria information 1300 according to the embodiment. The determination criteria information 1300 in FIG. 13 is, for example, determination criteria information 1300 for a change point 1 which is a first change point in the predetermined order. In the determination criteria information 1300, an entry is registered for each of the rotation frequency or each harmonic. An entry includes the rotation frequency or peak position and the peak intensity of the harmonic before the change point and after the change point which is associated with the determination criteria information 1300. In addition, the determination criteria information 1300 also includes information on the error range with respect to the peak position and the peak intensity.

For example, as described above, the control unit 901 may acquire positions and intensities of peaks of the rotation frequency and the harmonics of the rotation frequency for each process executed in the predetermined order and also acquire an error range with respect to the positions and intensities of the peaks.

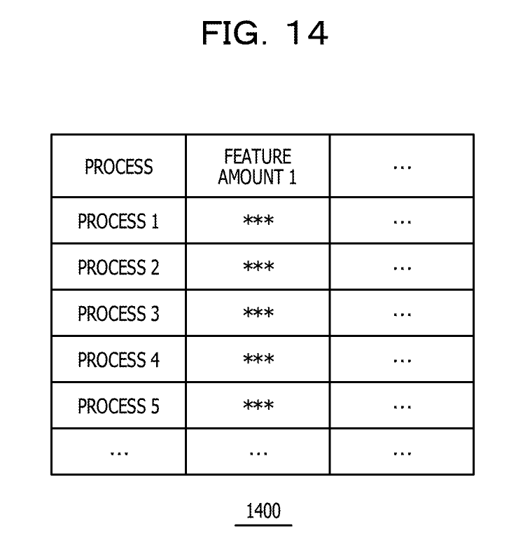

Subsequently, abnormality detection processing of the monitoring target device 101 according to the embodiment will be described. FIG. 14 is a diagram illustrating the feature amount information 1400. In the feature amount information 1400, an entry including a feature amount corresponding to each of the plurality of processes executed by the monitoring target device 101 is registered. An entry may include one or more feature amounts. For example, as illustrated in FIG. 2(c), the sum of the intensities in a predetermined frequency domain in the frequency spectrum obtained from the vibration data detected by the sensor 110 may be used as a feature amount. A frequency range to be used as a feature amount may be set to an arbitrary range, and for example, the frequency range defined by the International Organization for Standardization may be used as a feature amount. Alternatively, in another embodiment, a frequency range to be used as a feature amount may be set in a predetermined region that does not include the error range of the rotation frequency and the error range of the harmonic frequencies of the rotation frequency corresponding to the process specified by the determination criteria information 1300. For example, in a case where the frequency range of the feature amount is set in this way, since the peak based on the harmonics synthesized by the inverter or the like is not included in the feature amount, it is possible to suppress that the peak based on an abnormality is buried in the peak based on the harmonics synthesized by using the inverter or the like.

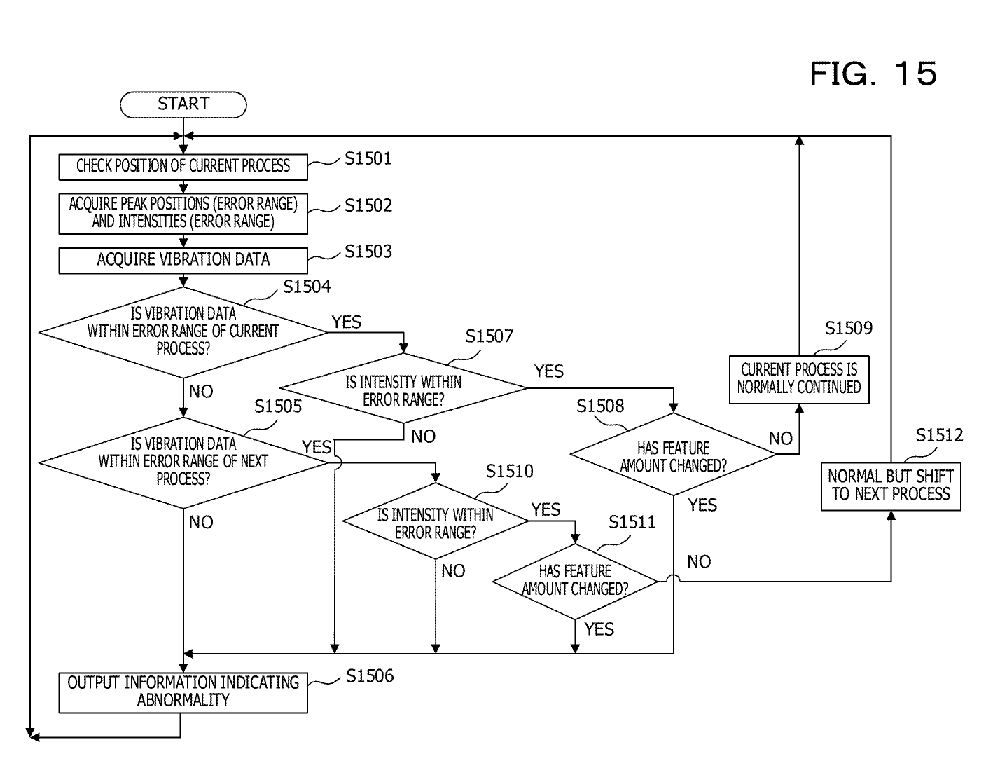

FIG. 15 is a diagram illustrating an operation flow of the abnormality detection processing according to the embodiment. The control unit 901 of the abnormality detection device 103 may start the abnormality detection processing of FIG. 15, for example, when an instruction to start detection of an abnormality of the monitoring target device 101 is input.

In S1501, the control unit 901 checks the position of a current process. For example, the storage unit 902 of the abnormality detection device 103 may store process order information indicating the execution order of the plurality of processes executed by the monitoring target device 101. In addition, the storage unit 902 may store process information indicating a process being executed, and the control unit 901 may update the process information to information indicating a shift destination process each time it is detected that the process executed by the monitoring target device 101 has shifted to the next process. In S1501, the control unit 901 may check the position of the current process by referring to the process information stored in the storage unit 902. In the operation flow of FIG. 15, in a case where the processing of S1501 is executed for the first time, information indicating the process may not be recorded in the process information, and in this case, the control unit 901 may determine that the current process is a first process and may record the information indicating the first process in the process information.

In S1502, the control unit 901 acquires peak positions of the rotation frequency and the harmonics of the rotation frequency together with the error range in the current process before the change point and in the next process after the change point and acquires peak intensities together with the error range from the determination criteria information 1300 corresponding to the change point between the current process and the next process.

In S1503, the control unit 901 acquires the latest vibration data from the sensor 110 provided in the monitoring target device 101. In S1504, the control unit 901 determines whether or not the frequency spectrum of the acquired vibration data is within the error range of the rotation frequency or a plurality of peak positions corresponding to the harmonics of the rotation frequency for the current process acquired from the determination criteria information 1300. That is, in a case where the error range is the standard deviation, the control unit 901 determines whether or not the frequency spectrum of the vibration data includes a peak in the range of the standard deviation from the rotation frequency or the plurality of peak positions of the harmonics of the rotation frequency for the current process. In a case where the frequency spectrum of the acquired vibration data does not include a peak in at least one error range of the rotation frequency or the plurality of peak positions corresponding to the harmonics of the rotation frequency for the current process acquired from the determination criteria information 1300 (NO in S1504), the flow proceeds to S1505. In this case, the frequency spectrum illustrates that there is an abnormality as the frequency spectrum for the current process indicated in the process information.

In S1505, the control unit 901 determines whether or not the frequency spectrum of the acquired vibration data is within the error range of the rotation frequency or the plurality of peak positions corresponding to the harmonics of the rotation frequency for the next process acquired from the determination criteria information 1300. That is, in a case where the error range is the standard deviation, the control unit 901 determines whether or not the frequency spectrum of the vibration data includes a peak in a range of the standard deviation from the rotation frequency or the plurality of peak positions of the harmonics of the rotation frequency for the next process. In a case where the frequency spectrum of the acquired vibration data does not include a peak in at least one error range of a plurality of peak positions for the next process acquired from the determination criteria information 1300 (NO in S 1505), the flow proceeds to S1506. In S1506, the control unit 901 outputs information indicating an abnormality, and the operation flow returns to S1501.

In addition, in S1504, in a case where the frequency spectrum of the vibration data includes a peak within the error range of the rotation frequency or the plurality of peak positions of the harmonics of the rotation frequency of the current process acquired from the determination criteria information 1300 (YES in S1504), the flow proceeds to S1507. In S1507, the control unit 901 determines whether or not the intensity of the peak of the frequency spectrum included in the error range of the plurality of peak positions for the current process is within the error range of the rotation frequency or the intensities of the harmonics of the rotation frequency of the current process of the determination criteria information 1300. In a case where the peak intensity of the frequency spectrum is not within the error range of the rotation frequency or the intensities of the harmonics of the rotation frequency of the current process of the determination criteria information 1300 (NO in S1507), it is considered that the peak based on an abnormality overlaps with the peak corresponding to the rotation frequency or the harmonics of the rotation frequency of the current process. Therefore, the flow proceeds to S1506, and the control unit 901 outputs information indicating an abnormality. On the other hand, in a case where the intensity of the peak of the frequency spectrum is within the error range of the rotation frequency or the intensities of the harmonics of the rotation frequency of the current process (YES in S1507), the flow proceeds to S1508.

In S1508, the control unit 901 compares the feature amount corresponding to the current process acquired from the feature amount information 1400 with the feature amount obtained from the same frequency range of the frequency spectrum of the vibration data to determine whether or not the feature amount has changed beyond a predetermined error range. For example, by setting the frequency domain for acquiring the feature amount to be used for determination to a region that does not include the rotation frequency and the peaks of the harmonics of the rotation frequency of the current process and registering the frequency domain in the feature amount information 1400, it is possible to detect an abnormality without being affected by the harmonics synthesized by the inverter or the like. Then, in a case where the feature amount changes beyond the predetermined error range (YES in S1508), it is considered that a peak based on an abnormality is occurring in the region other than the rotation frequency or the peak positions of the harmonics of the rotation frequency of the current process. Therefore, the flow proceeds to S1506, and the control unit 901 outputs information indicating an abnormality. On the other hand, in a case where the feature amount has not changed beyond the predetermined error range (NO in S1508), the flow proceeds to S1509, it is determined that the current process is normally continued, and the flow returns to S1501.

In addition, in S1505, in a case where the frequency spectrum of the vibration data includes a peak within the error range of the rotation frequency or the plurality of peak positions of the harmonics of the rotation frequency of the next process acquired from the determination criteria information 1300 (YES in S1505), the flow proceeds to S1510. In S1510, the control unit 901 determines whether or not the intensity of the peak of the frequency spectrum included in the error range of the plurality of peak positions for the next process is within the error range of the rotation frequency or the intensities of the harmonics of the rotation frequency of the next process of the determination criteria information 1300. In a case where the peak intensity of the frequency spectrum is not within the error range of the rotation frequency or the intensities of the harmonics of the rotation frequency of the next process (NO in S1510), it is considered that the peak based on an abnormality is occurring, overlapping with the peak corresponding to the rotation frequency or the harmonics of the rotation frequency of the next process. Therefore, the flow proceeds to S1506, and the control unit 901 outputs information indicating an abnormality. On the other hand, in a case where the intensity of the peak of the frequency spectrum is within the error range of the rotation frequency or the intensities of the harmonics of the rotation frequency of the next process (YES in S1510), the flow proceeds to S1511.

In S1511, the control unit 901 compares the feature amount corresponding to the next process acquired from the feature amount information 1400 with the feature amount obtained from the same frequency range of the frequency spectrum of the vibration data to determine whether or not the feature amount changes beyond a predetermined error range. For example, by setting the frequency domain for acquiring the feature amount to be used for determination to a region that does not include the rotation frequency and the peaks of the harmonics of the rotation frequency of the next process and registering the frequency domain in the feature amount information 1400, it is possible to detect an abnormality without being affected by the harmonics synthesized by the inverter or the like. In a case where the feature amount changes beyond the predetermined error range (YES in S1511), it is considered that a peak based on an abnormality is occurring in the region other than the peak position of the rotation frequency or the harmonics of the rotation frequency of the next process. Therefore, the flow proceeds to S1506, and the control unit 901 outputs information indicating an abnormality. On the other hand, in a case where the feature amount has not changed beyond the predetermined error range (NO in S1511), the flow proceeds to S1512. In S1512, the control unit 901 determines that the monitoring target device 101 is operating normally but shifts to the next process and updates the process information to information indicating the next process, and the flow returns to S1501.

As described above, according to the embodiment, the control unit 901 detects an abnormality based on a plurality of determination criteria for each process generated based on the rotation frequency of the rotating part and the harmonic frequencies of the rotation frequency of each process. For this reason, it is possible to distinguish between process switching and occurrence of an abnormality with high accuracy, as compared with a case where determination is performed by using feature amounts obtained by setting an arbitrary frequency domain in a fixed way.

For example, the control unit 901 detects that the frequency spectrum of the vibration data from the sensor 110 includes a peak in the rotation frequency of the rotating part and the peripheral regions of the harmonic frequencies of the rotation frequency corresponding to the current process. In this case, in this case, the control unit 901 may determine that the current process is being continuously executed. Thereafter, in a case where a peak is no longer detected in either in the rotation frequency or the peripheral regions of the harmonic frequencies of the rotation frequency corresponding to the current process, it is determined whether or not a peak is included in the rotation frequency and the peripheral regions of the harmonic frequencies of the rotation frequency corresponding to the next process. Then, for example, in a case where a peak is included in the rotation frequency and the peripheral regions of the harmonic frequencies of the rotation frequency of the next process, the control unit 901 may determine that the process is switched. On the other hand, in a case where a peak is not detected in at least one peripheral region of the rotation frequency and the peripheral regions of the harmonic frequencies of the rotation frequency corresponding to the next process, an abnormality may be determined.

In addition, for example, in the above embodiment, in a case where the frequency spectrum of the vibration data includes a peak in the rotation frequency and the peripheral regions of the harmonic frequencies of the rotation frequency of the current process, the control unit 901 next compares the peak intensities to determine whether or not the peak intensity falls within the error range of normal peak intensities. In a case where the peak intensity deviates by a predetermined error range from the peak intensity at the normal rotation frequency and the harmonic frequencies of the rotation frequency, it is considered that an abnormal peak is occurring, overlapping with the rotation frequency or the peaks of the harmonic frequencies of the rotation frequency of the current process. Therefore, the control unit 901 may also determine that there is an abnormality also in this case.

In addition, in the above-described embodiment, in a case where the frequency spectrum of the vibration data includes a peak in the rotation frequency and the peripheral regions of the harmonic frequencies of the rotation frequency of the next process, next, the peak intensities are compared and it is determined whether or not the peak intensity falls within the error range of the normal peak intensities of the next process. Therefore, it is possible to quickly detect the occurred abnormality at the same time as switching to the next process of the process.

In addition, in the operation flow of FIG. 11 described above, harmonic frequencies in each process are specified by first specifying a rotation frequency and using the frequency obtained by multiplying the rotation frequency by an integral number as an initial search position to search for a peak within an error range corresponding to the resolution of the frequency spectrum set around the initial search position. Therefore, it is possible to specify harmonic frequencies of the rotation frequency with high accuracy. Then, it is possible to detect process switching and an abnormality from the frequency spectrum of the vibration data from the sensor 110 by recording the rotation frequency and the harmonic frequencies of the rotation frequency in each of the plurality of processes executed by the monitoring target device 101 operating normally in the past.

In addition, furthermore, even in a case where the rotation frequency of the rotating part of the monitoring target device 101 is controlled by using the inverter or the like, the position and the intensity are compared for each peak of the rotation frequency and the harmonics of the rotation frequency. Therefore, for example, in a case where a peak due to an abnormality occurs in a region not including the peaks of the harmonics synthesized by the inverter, it is possible to detect the abnormality with high accuracy. In addition, as described above, in each process, it is possible to detect an abnormality without being affected by the peaks of the harmonics synthesized by the inverter or the like by setting the frequency range for acquiring a feature amount to the region not including the rotation frequency and the peaks of the harmonics of the rotation frequency.

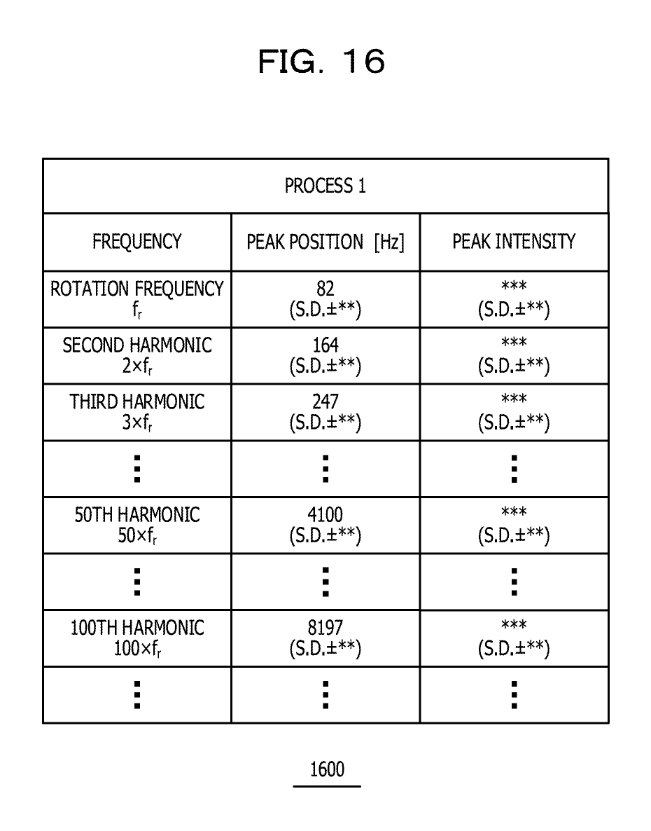

In the above-described embodiment, the case where the determination criteria information 1300 is generated for each change point and the determination criteria information 1300 includes information on the rotation frequency and the harmonic before and after the change point is illustrated as an example. However, the embodiment is not to be found therein. For example, as illustrated in FIG. 16, the determination criteria information 1300 may include information on the rotation frequency and information on the harmonics of the rotation frequency generated for each process.

Although the embodiment is exemplified above, the embodiment is not limited thereto. For example, the above-described operation flow is an example, and the embodiment is not limited thereto. If possible, the operation flow may be executed by changing the order of processing and may include another processing separately, or some processing may be omitted. For example, the processing in S1502 and S1503 in FIG. 15 may be executed while changing the order. In addition, S1509 in FIG. 15 may be omitted.

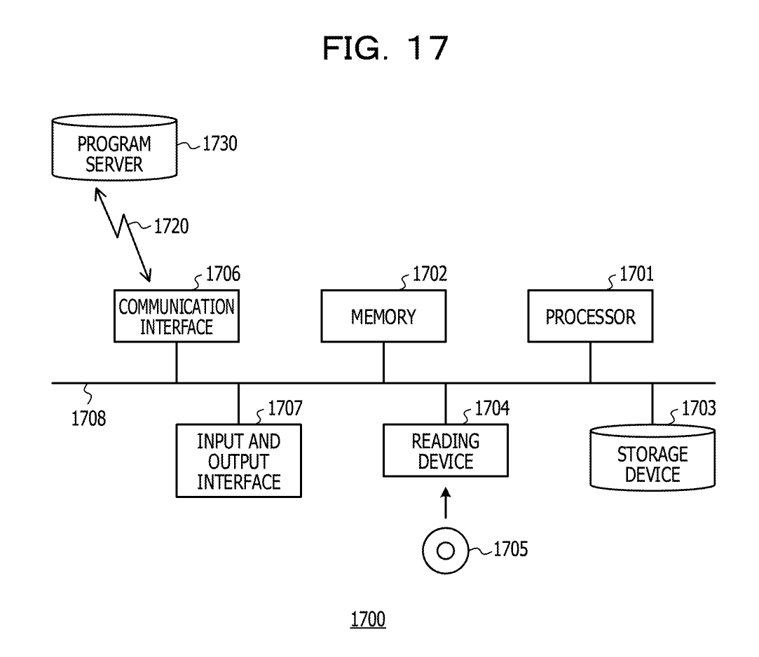

FIG. 17 is a diagram illustrating a hardware configuration of a computer 1700 for realizing the abnormality detection device 103 according to the embodiment. The hardware configuration for realizing the abnormality detection device 103 in FIG. 17 includes, for example, a processor 1701, a memory 1702, a storage device 1703, a reading device 1704, a communication interface 1706, and an input and output interface 1707. The processor 1701, the memory 1702, the storage device 1703, the reading device 1704, the communication interface 1706, and the input and output interface 1707 are connected to each other via a bus 1708, for example.

By using the memory 1702, the processor 1701, for example, executes a program describing the procedure of the above-described operation flow, thereby providing a part or all of the functions of the control unit 901 described above. In addition, the above-described storage unit 902 includes, for example, the memory 1702, the storage device 1703, and a detachable storage medium 1705. In the storage device 1703 of the abnormality detection device 103, for example, the determination criteria information 1300, the feature amount information 1400, and the like are stored.

The memory 1702 is, for example, a semiconductor memory and may include a RAM area and a ROM area. The storage device 1703 is, for example, a semiconductor memory such as a hard disk, a flash memory, or an external storage device. RAM is an abbreviation for Random Access Memory. In addition, ROM is an abbreviation for Read Only Memory.

The reading device 1704 accesses the detachable storage medium 1705 in accordance with instructions from the processor 1701. The detachable storage medium 1705 is, for example, a semiconductor device (such as a USB memory), a medium to and from which information is input and output by magnetic action (such as a magnetic disk), a medium (CD-ROM, DVD, and the like), and the like. USB is an abbreviation for Universal Serial Bus. CD is an abbreviation for Compact Disc.

DVD is an abbreviation for Digital Versatile Disk.

The communication interface 1706 transmits and receives data via a network 1720 in accordance with instructions from the processor 1701. For example, the processor 1701 may acquire the vibration data measured by the sensor 110 from the relay device 102 via the communication interface 1706. The input and output interface 1707 may be, for example, an interface between an input device and an output device. The input device is, for example, a device such as a keyboard or a mouse for receiving an instruction from the user. The output device is, for example, a display device such as a display, and an audio device such as a speaker.

Each program according to the embodiment is provided in the abnormality detection device 103, for example, in the following form.

(1) Preinstalled in the storage device 1703.

(2) Provided by the detachable storage medium 1705.

(3) Provided from a program server 1730.

The hardware configuration of the computer 1700 for realizing the abnormality detection device 103 described with reference to FIG. 17 is an example, and the embodiment is not limited thereto. For example, a part or all of the functions of the functional units described above may be implemented as hardware such as FPGA and SoC. FPGA is an abbreviation for Field Programmable Gate Array. SoC is an abbreviation for System-on-a-Chip.

Several embodiments are described above. However, the embodiments are not limited to the above-described embodiments, but are supposed be understood as encompassing various modifications and alternatives of the above-described embodiments. For example, it will be understood that various embodiments may be embodied by modifying constituent elements without departing from the spirit and scope thereof. In addition, it will be understood that various embodiments may be implemented by appropriately combining a plurality of constituent elements disclosed in the above embodiments. Furthermore, those skilled in the art will understand that various embodiments may be implemented by deleting or replacing some constituent elements from all the constituent elements illustrated in the embodiments, or by adding some constituent elements to the constituent elements illustrated in the embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein an abnormality detection program for causing a computer to execute a process, the process comprising:
referring to a storage that stores a plurality of determination criteria for each of processes based on a rotation frequency of the rotating part and harmonic frequencies of the rotation frequency in each of a plurality of processes, the rotation frequency and the harmonic frequencies of the rotation frequency being specified from a frequency spectrum of vibration data obtained by measuring, by a sensor, vibration of a monitoring target device that executes the plurality of processes in a predetermined order by using a rotating part that rotates; and
detecting occurrence of an abnormality of the monitoring target device from the vibration data measured by the sensor based on the predetermined order and the plurality of determination criteria for each of the processes.

2. The computer-readable recording medium according to claim 1,
wherein the plurality of determination criteria for each of the processes are information indicating a plurality of frequency domains corresponding to the respective processes set around each of the rotation frequency and the harmonic frequencies of the rotation frequency in each process, and
the processing of detecting includes
after detecting that the frequency spectrum obtained by converting the vibration data measured by the sensor includes a peak in the plurality of frequency domains corresponding to a first process of the plurality of processes, in a case where no peak is detected in at least one frequency domain of the plurality of frequency domains corresponding to the first process, determining whether or not the frequency spectrum includes a peak in the plurality of frequency domains corresponding to a second process performed after the first process, and
in a case where the frequency spectrum does not include a peak in at least one frequency domain of the plurality of frequency domains corresponding to the second process, outputting information indicating an abnormality.

3. The computer-readable recording medium according to claim 2,
wherein the storage further stores a peak intensity corresponding to each of the rotation frequency and the harmonic frequencies of the rotation frequency in the first process, and
the processing of detecting includes
in a case where it is detected that the frequency spectrum includes a peak in the plurality of frequency domains corresponding to the first process stored in the storage, outputting information indicating an abnormality when the intensity of the peak included in the plurality of frequency domains is not within a predetermined error range from the peak intensity corresponding to each of the rotation frequency and the harmonic frequencies of the rotation frequency in the first process.

4. The computer-readable recording medium according to claim 2,
wherein the storage further stores a peak intensity corresponding to each of the rotation frequency and the harmonic frequencies of the rotation frequency in the second process, and
the processing of detecting includes
in a case where it is detected that the frequency spectrum includes a peak in the plurality of frequency domains corresponding to the second process stored in the storage, outputting information indicating an abnormality when the intensity of the peak included in the plurality of frequency domains corresponding to the second process is not within a predetermined error range from the peak intensity corresponding to each of the rotation frequency and the harmonic frequencies of the rotation frequency in the second process.

5. The computer-readable recording medium according to claim 2,
wherein the storage further stores a feature amount of the first process corresponding to a predetermined frequency domain not including the plurality of frequency domains corresponding to the first process, and
the processing of detecting includes
in a case where it is detected that the frequency spectrum includes a peak in the plurality of frequency domains corresponding to the first process stored in the storage, determining whether or not the feature amount acquired from the predetermined frequency domain of the frequency spectrum is within a predetermined error range from the feature amount of the first process stored in the storage, and
in a case where the feature amount indicates a value exceeding the predetermined error range from the feature amount of the first process stored in the storage, outputting information indicating an abnormality.

6. The computer-readable recording medium according to claim 1, the process further comprising:
specifying the rotation frequency of the first process based on a frequency of a peak having an intensity equal to or higher than a predetermined intensity detected by searching a past frequency spectrum converted from past vibration data detected by the sensor in the first process executed in the past from a low-frequency side;
determining an initial search position for searching for a peak of a harmonic of the rotation frequency of the first process based on the rotation frequency of the first process;
specifying the harmonic frequencies of the rotation frequency in the first process based on a frequency of a detected peak by searching from the initial search position to a predetermined error range based on resolution of the past frequency spectrum; and
storing the plurality of determination criteria for the first process set based on the rotation frequency in the first process and the harmonic frequencies of the rotation frequency in the first process in the storage.

7. An abnormality detection method executed by a computer, the method comprising:
referring to a storage that stores a plurality of determination criteria for each of processes based on a rotation frequency of the rotating part and harmonic frequencies of the rotation frequency in each of a plurality of processes, the rotation frequency and the harmonic frequencies of the rotation frequency being specified from a frequency spectrum of vibration data obtained by measuring, by a sensor, vibration of a monitoring target device that executes the plurality of processes in a predetermined order by using a rotating part that rotates; and
detecting occurrence of an abnormality of the monitoring target device from the vibration data measured by the sensor based on the predetermined order and the plurality of determination criteria for each of the processes.

8. An abnormality detection device comprising:
a memory: and
a processor coupled to the memory, the processor configured to
referring to a storage that stores a plurality of determination criteria for each of processes based on a rotation frequency of the rotating part and harmonic frequencies of the rotation frequency in each of a plurality of processes, the rotation frequency and the harmonic frequencies of the rotation frequency being specified from a frequency spectrum of vibration data obtained by measuring, by a sensor, vibration of a monitoring target device that executes the plurality of processes in a predetermined order by using a rotating part that rotates, and
detecting occurrence of an abnormality of the monitoring target device from the vibration data measured by the sensor based on the predetermined order and the plurality of determination criteria for each of the processes.
